(19) United States
(12) Patent Application Publication
(10) Pub. No.: US 2014/0351419 A1
(43) Pub. Date: Nov. 27, 2014

(54) AUTOMATIC DATA RING DISCOVERY AND CONFIGURATION

(71) Applicant: Exablox Corporation, Sunnyvale, CA (US)

(72) Inventors: Tad Hunt, Sunnyvale, CA (US); Frank E. Barrus, New Ipswich, NH (US)

(21) Appl. No.: 14/284,351

(22) Filed: May 21, 2014

Related U.S. Application Data
(60) Provisional application No. 61/825,890, filed on May 21, 2013.

(51) Int. Cl. H04L 12/26

(52) U.S. Cl. CPC H04L 43/08
USPC 709/224

(57) ABSTRACT

Computer-implemented methods and systems for automatic ring discovery and configuration are provided. An exemplary method may comprise connecting a data node to a network. When connected, the data node periodically sends an advertisement to the network and monitors the network for one or more further advertisements of further data nodes associated with one or more data rings. The monitoring is performed for a predetermined time period. If one or more further advertisements are received, the data node determines which data ring to join using predefined criteria. The predetermined criteria may include a number of data nodes in the data ring, free space in the data ring, allowable number of the data nodes, compatibility of software versions of the data node and the data ring. Alternatively, if no advertisements are received within the predetermined time period, the data node creates a new data ring.

### RELATED APPLICATIONS

The present application claims the benefit of U.S. provisional application No. 61/825,890, filed May 21, 2013, and entitled “Automatic Data Ring Discovery and Configuration”. The disclosure of the aforementioned application is incorporated herein by reference for all purposes.

### TECHNICAL FIELD

This disclosure relates generally to data management, and more specifically to automatic data cluster discovery and configuration.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Some data storage architectures may require that data storage devices (also known as data nodes) form data clusters. New data nodes can be used to expand an existing cluster or to form a new cluster. When a new data node is deployed, the new data node can join an existing cluster or, if no cluster exists, form a new cluster. Conventionally, such additions to existing data clusters are configured manually. Manual configuration can be time-consuming and require qualified staff to perform it.

Additionally, in traditional storage systems, when a new storage device is added, the new storage device exports one or more network shares onto the network, with each network share having its own namespace. Thus, a user must decide how to utilize these network shares, often resulting in misconfiguration and inefficient use of resources.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with one embodiment, a data node capable of auto-joining a data ring is provided. The data node may connect to a network. After connecting, the data node can send an advertisement to the network to notify other data nodes of its presence and status. The advertisement can include information concerning the data node. Additionally, the data node can monitor the network for advertisements broadcast by other data nodes. Advertisements of a data node joined to a data ring can include a ring identifier, data node identifier, various attributes, a software version, an allowable number of nodes, and so forth.

The data node can continue monitoring the network for a predetermined time period. If no advertisements are received within the predetermined time period, the data node creates a new data ring. If some advertisements are received within the predetermined time period, the data node joins one of the data rings described by the received advertisements. To determine which data ring to join when multiple rings are detected, the data node uses various predetermined criteria. Some examples of predetermined criteria can include capacity of the data rings, number of nodes in the data rings, how much free space the data rings have, compatibility of the new data node and rings' software versions, or any combination of these or other criteria. In some embodiments, the data node randomly chooses which data ring to join.

The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements.

FIG. 1 shows a simplified computer network infrastructure, in accordance with some embodiments.

FIG. 2 shows a graphical representation of a new data node joining a data ring.

FIG. 3 shows a graphical representation of a new data node creating a new data ring.

FIG. 4 is a flow chart illustrating a procedure of adding a new data node to a computer network infrastructure.

FIG. 5 is a flow chart illustrating another method for auto-joining a data node to a data ring, in accordance with some embodiments.

FIG. 6 is a block diagram showing modules of a system for auto-joining a data node to a data ring.

FIG. 7 shows a diagrammatic representation of a computing device for a machine in the exemplary electronic form of a computer system, within which a set of instructions for causing the machine to perform any one or more of the methodologies discussed herein, can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed.

The approaches and principles disclosed herein relate to computer-implemented methods and systems for auto-discovery and auto-joining of a data node to a data ring within a computer network infrastructure. The computer network infrastructure includes a plurality of data nodes each having storage resources for storing various data objects and enabling access to them from other nodes. Moreover, the storage resources of a single node may include one or a plurality of hard drives, solid state drives, or other memory devices such as RAM (random-access memory) or ROM (read-only memory). Data nodes may be joined in a data ring having a global namespace.

When a new data node is added to the computer network infrastructure, it may automatically discover data rings existing in the computer network infrastructure and join one of the discovered rings according to predefined criteria. If no data rings are discovered, the data node may automatically create a new data ring.

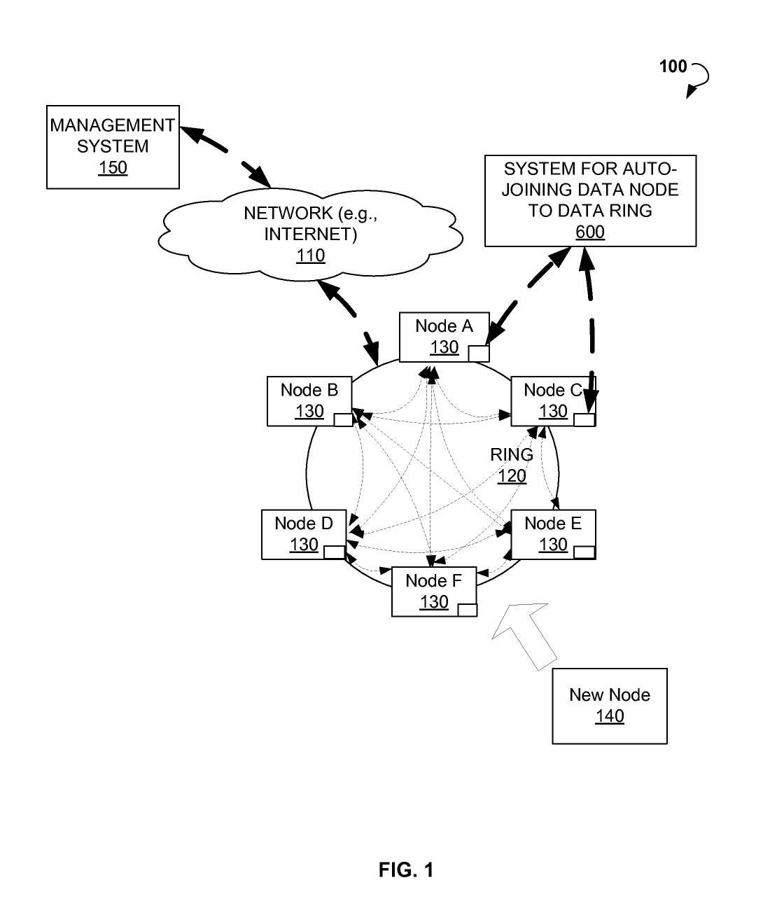

The present disclosure provides systems and methods for auto-discovery and auto-joining data nodes to data rings. Data nodes may be joined in data rings forming common storage pools that have a common global namespace. To form such a ring or to join a new data node to an existing ring, a data node may automatically discover existing data rings and automatically join one of them. If no data rings are discovered, the data ring may automatically create a new data ring. Thus, manual operations related to ring creation and joining new data node to rings may be avoided. This process is illustrated in more detail with reference to FIG. 1.

FIG. 1 is a simplified computer network infrastructure 100, in accordance with some example embodiments. The computer network infrastructure 100 includes a data ring 120 comprising nodes A-F 130. Each of the nodes A-F 130 may include any suitable networking elements that maintain a network address and can store and share data objects with other nodes. In an example embodiment, the nodes A-F 130 may refer to a computer, a server, a laptop, a tablet computer, a thin client, or any other electronic computing device suitable for storing and sharing data. Furthermore, each of the nodes A-F 130 may include multiple storage devices such as hard disk drives, solid state drives, RAM, ROM, flash memory, and so forth.

As shown in FIG. 1, the data ring 120 may include nodes A-F 130. Logical connections between the nodes A-F 130 in the data ring 120 may form a mesh topology. Thus, each node 130 may share data with each node 130 of the data ring 120. For example, data communications associated with nodes A and B 130 are shown by arrows leading to other nodes of the data ring 120. The nodes A-F 130 may communicate over a network such as, for example, LAN or a WAN.

The data ring 120 may have a common global namespace associated with the nodes A-F 130. Because of the common global namespace, the nodes A-F 130 may be presented to a user as a single entity. Thus, in contrast to conventional systems, the data nodes A-F 130 may be combined into a common storage pool with the capacity of all constituent nodes. Thus, the data nodes 130 may be bound together to potentially scale to very large file systems.

The ring 120 may communicate with a management system 150 via a network 110. The management system 150 may control configuration of the ring 120 and manage various processes in the ring 120. When a new node 140 is connected to a computer network infrastructure 100 such as, for example, a LAN, it may either join the ring 120 or form a new ring using a system 600 for auto-joining data node to data ring.

The network 110 can include the Internet or any other network capable of communicating data between devices. Suitable networks can include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 includes a network of data processing nodes that are interconnected for the purpose of data communication.

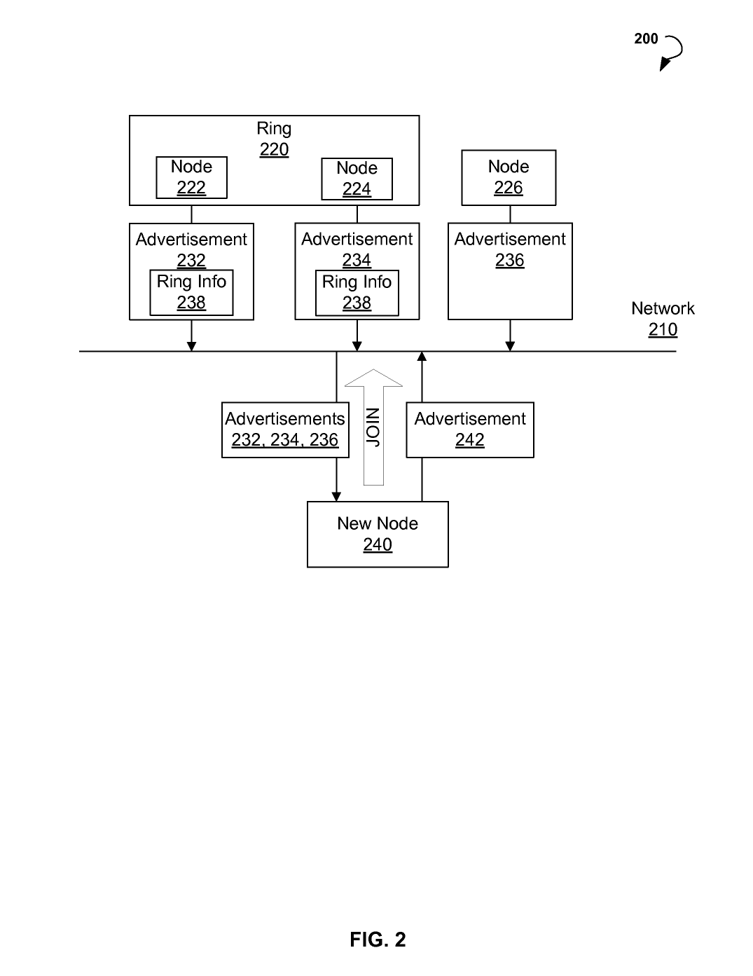

Referring now to FIG. 2, a new node 240 may be connected to network 210. The network 210 may include other devices, data nodes, data rings, and so forth. As FIG. 2 shows, the network 210 includes ring 220 and a node 226. The ring 220, in turn, includes node 222 and node 224. After the new node 240 is connected to network 210, it may use a multicast protocol to advertise to every device on the network 210 that the new node 240 was added to the network 210. It will be understood that the advertising is not limited to new nodes and every node always advertises itself including those nodes that are already members of a ring. Each node is responsible for advertising itself using various multicast protocols. For example, the Multicast Domain Name System (mDNS) and DNS Service Discovery (DNS-SD) can be used to advertise the presence of the new node 240 to other devices.

The mDNS protocol is published as Request for Comments (RFC) 6762 and the DNS Service Discovery protocol is published as Request for Comments (RFC) 6763 and are incorporated herein by reference in their entirety for all purposes.

The new node 240 may send an advertisement 242 to the network 210. The advertisement 242 may include node ID, software version, and some other attributes. If the new node 240 has no ring ID it may advertise none, and the ring ID may be updated after the new node 240 joins a ring.

Auto-discovery may commence with the new node 240 listening for advertisements made by other devices on the network 210.

Advertisements 232 and 234 from nodes 222 and 224 joined to the ring 220 may differ from advertisement 236 emitted by the single node 226. Although all advertisements can include information related to the node (e.g., node ID, software version, and the like), the nodes 222 and 224 joined to the ring 220 also include ring information 238. The ring information 238 can include ring ID, an allowable number of nodes, and other attributes.

The new node 240, after listening for a while and hearing advertisements 232, 234, 236 from the nodes 222, 224,226, may decide to join the ring 220. On the other hand, the new node 240 may monitor (or listen) on the network 210 for a predetermined period of time and receive no advertisement.

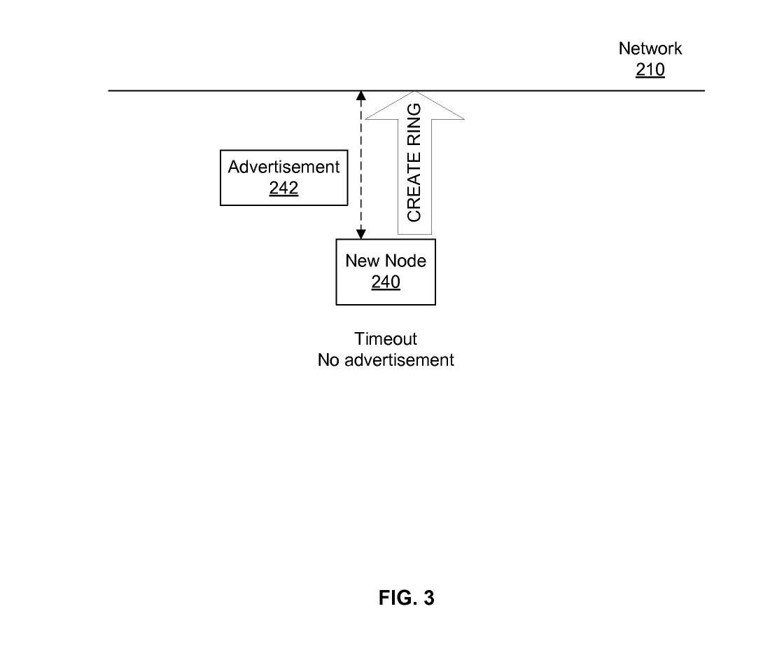

Referring now to FIG. 3, the network 210 may not have any devices or rings. If the new node 240 sends advertisement 242 and hears no advertisements, it can create a new ring ID, and make itself a member of a new ring, thus becoming the only member of the new ring as illustrated in FIG. 3. After the new node 240 creates the new ring, it can update its advertisement with the new ring ID. Once the new node 240 is a ring participant, it stops monitoring for new advertisements while continuing advertising itself. Thus, it will be understood that listening for advertisements is done by nodes that are not yet members of a ring.

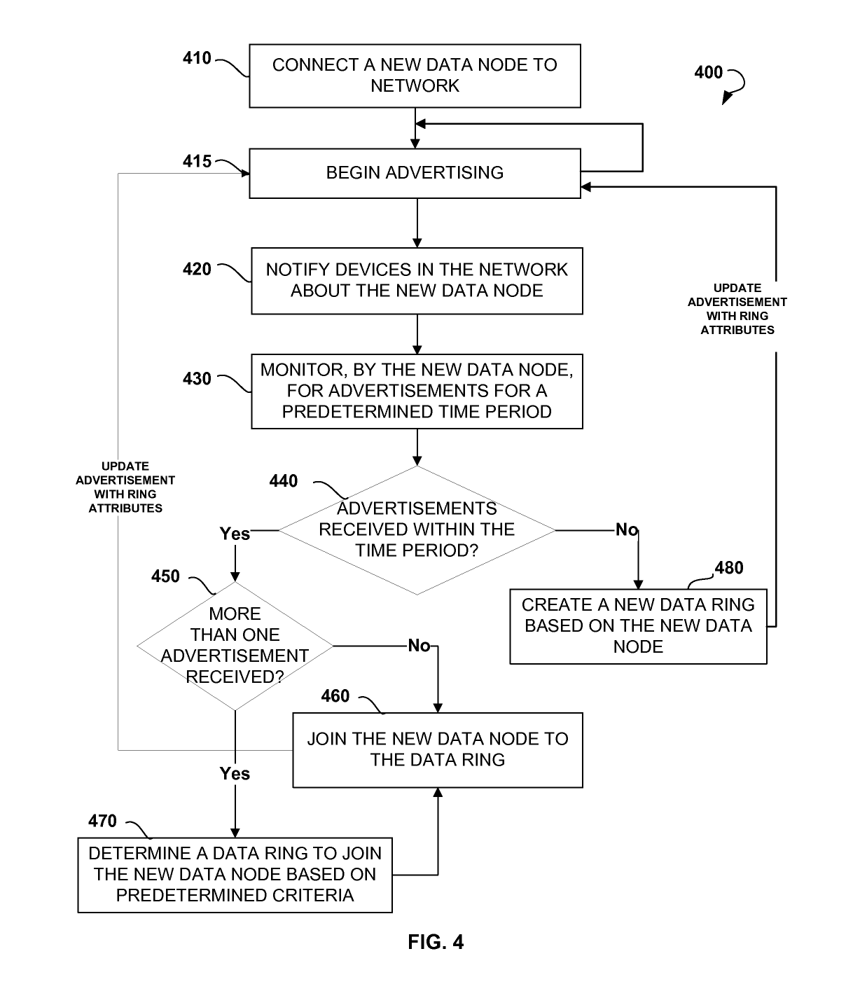

FIG. 4 shows operations flow 400 related to auto-discovery of rings in a network and auto-creation of a new ring by a new node. A new data node may be connected to a network, such as, for example, a LAN, at operation 410. At operation 415, the new node may begin advertising.

Devices in the network to which the new data node is connected can be notified about the new data node at operation 420.

At operation 430, the data node may monitor for advertisements of other devices and/or rings for a predetermined period of time. It may be determined whether the advertisements are received within the time period at operation 440. If no advertisements are received, the data node may create a new data ring at operation 480. Upon creation of a new ring, a ring ID may be generated. Then, the advertisement is updated with the new ring ID.

However, if advertisements are received, it may be determined at operation 450. If all advertisements received are from data nodes in the same ring, the data node may join the data ring, from which the only advertisement is received at operation 460. After joining the ring, the advertisement with ring attributes can be updated. If advertisements identifying more than one ring is received, the data node can determine which data ring to join based on predetermined criteria at operation 470. It should be understood that the new node may also choose to join no rings and create a new data ring based on the new data node at operation 480. For example, the new node may decide not to join any rings when the ring attributes are not compatible with the new node. Alternatively, the new node may decide not to join an existing ring and not to create a new data ring. Instead the node may continue with operation 415, that is continue advertising until there is a ring to join or no other rings are available.

The predetermined criteria may include various factors. For example, the determination can be made based on whether the software of the joining node is compatible with the software that is run by other members of the ring. Other factors may also be considered in the decision process, for example, the combined free space of the data nodes in the rings can be compared. The ring with the smallest free space can be chosen. Alternatively, a ring with the least number of data nodes can be selected.

In some embodiments, a ring can have its auto-join functionality disabled. If this is the case, the new data node may not automatically join the ring. Accordingly, the ring with the auto-join disabled can be ignored by the new data node.

In some embodiments, only a certain maximum number of member data nodes can be allowed by a ring. This number can be based on the software version of the data node associated with the ring. If data nodes in the same ring allow different number of members, the allowable number of members in the ring is determined by the data node allowing the least number of members.

If, for some reason, the data node is rejected by a ring, the node may go into auto-discovery process again and ignore the rejecting ring. In such case, the process of determining a data ring to join can be repeated over all remaining rings.

In some embodiments, to ensure random selection of rings, the rings can be sorted by their ring IDs which may be random. For example, a node may first try to join the ring with the smallest ID. It should be understood that the foregoing criteria for joining rings represent just a few non-exhaustive examples and other criteria can be used as well.

When the ring is selected, the data node may join the ring at operation 460. After joining the new data node, the capacity of the node becomes available to the ring without having to perform any configurations. Additionally, the configuration of the ring can be shared with the node, for example, access permissions can be propagated to the node and kept in synch with the ring.

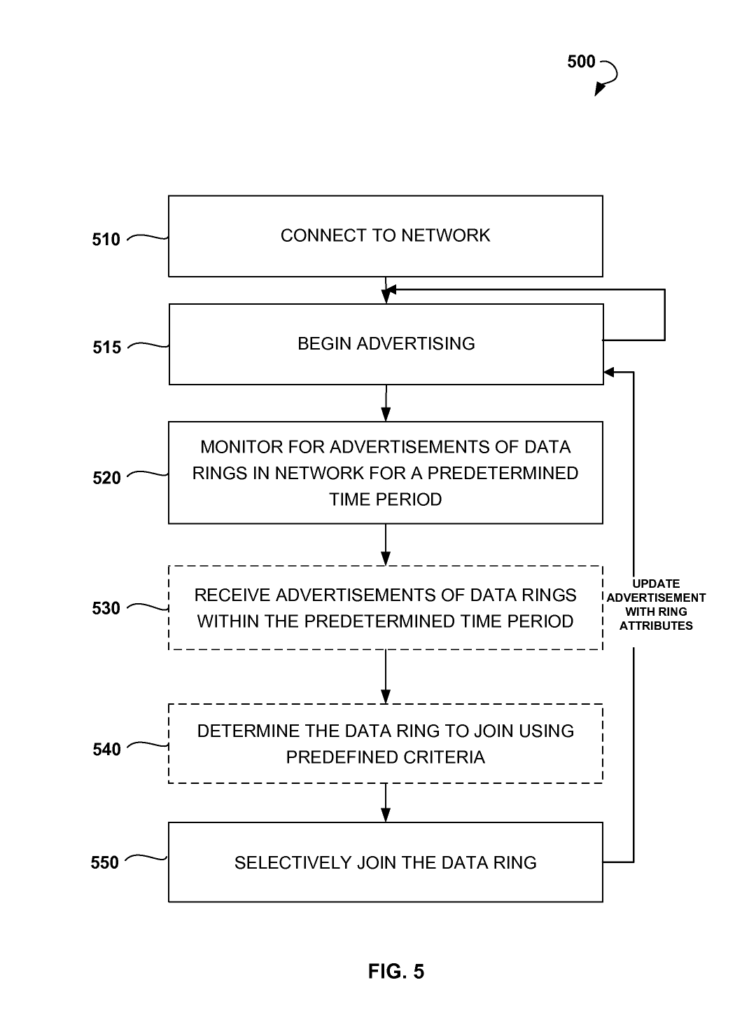

FIG. 5 is a process flow diagram showing a method 500 for auto-joining a data node to a data ring within a computer network infrastructure 100. The method 500 may be performed by logic that may comprise hardware (e.g., dedicated logic, programmable logic, and microcode), software (such as software run on a general-purpose computer system or a dedicated machine), or a combination of both. In one exemplary embodiment, the processing logic resides at a data node capable of auto-joining a data ring, and the various elements of the data node can perform the method 500. It will be appreciated by one of ordinary skill that examples of the foregoing modules can be virtual, and instructions said to be executed by a module may, in fact, be retrieved and executed by the data node. Although various elements may be configured to perform some or all of the various operations described herein, fewer or more elements may be provided and still fall within the scope of various embodiments.

As shown in FIG. 5, the method 500 may commence at operation 510 with a data node connecting to a local area network. The network may have other data nodes, data rings, and other devices connected. To notify the devices on the network about the new data node, information associated with the data node may be transmitted over the network using a multicast protocol. For this purpose, Multicast DNS, Bonjour, or Rendezvous protocols can be used. The notification may include various information 220 related to the new node 140, including a ring ID, node ID, a software version, an allowable number of nodes, and some other attributes. Node IDs and ring IDs are guaranteed to be unique and sortable. At operation 515, the new node may begin advertising which continues even after the new data node joins a ring. At operation 520, the data node may start monitoring the network for advertisements by data rings. The monitoring may continue for a predetermined period of time. Within the predefined period of time advertisements of data rings in the network may be received at optional operation 530. If only one advertisement is received, the method may proceed to attempt joining the data node to the data ring, at operation 550. If multiple advertisements are received, an appropriate data ring may be determined using predefined criteria at optional operation 540.

In various embodiments, the predefined criteria may include a number of the data nodes in the data ring, amount of free space in the data rings, allowable number of the data nodes in the data ring, actual number of the data nodes in the data ring, compatibility of software versions of the data node and the data ring, and so forth. In other embodiments, the data node may be joined to a random data ring. If that random data ring rejects the data node, the data node may attempt joining another random data ring, and so forth. Once a data ring is determined, the data node may join the data ring at operation 550. In some embodiments, after the data node joins to the data ring, the storage within the data node may be added to a global namespace associated with the data ring.

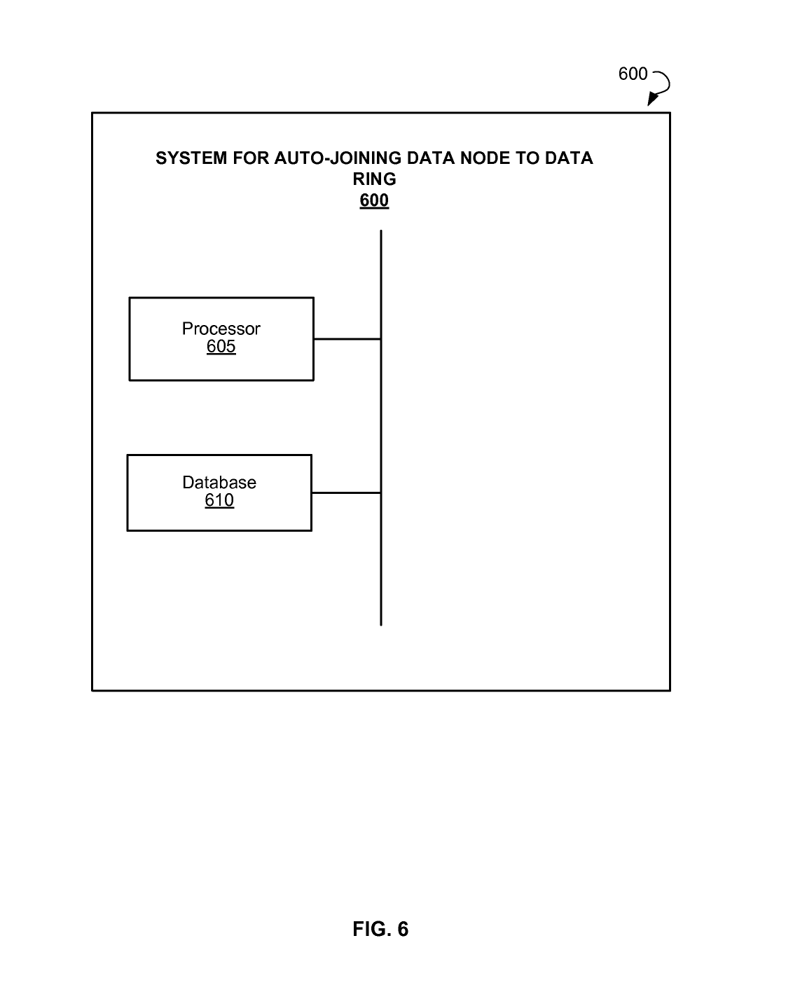

FIG. 6 is a block diagram showing modules of a system 200 for auto-joining a data node to a data ring, in accordance with certain embodiments. Specifically, the system 600 for auto-joining a data node to a data ring can include a processor 605 and a database 610. The processor 605 can include a programmable processor, such as a microcontroller, a central processing unit (CPU), and so forth. In other embodiments, the processor 605 can include an application-specific integrated circuit (ASIC) or programmable logic array (PLA), such as a field programmable gate array (FPGA), designed to implement the functions performed by the system 600. The processor 605 can be configured to connect the data node to a network. When connected, the data node can monitor advertisements from data rings associated with the network for a predetermined time period. If advertisements are received, the processor 605 can select one of the data rings using predefined criteria and auto-join the data node to the selected data ring. The data ring can refuse to join the data node. In that case, the processor 605 can repeat the steps of monitoring and selecting the data ring. If no advertisement is received within the predetermined time period or the data ring cannot join any of the data rings because of refusal by the data ring, incompatibility or other reasons, a new data ring can be created based on the data node. The database 610 can store data associated with the one or more data rings and other information.

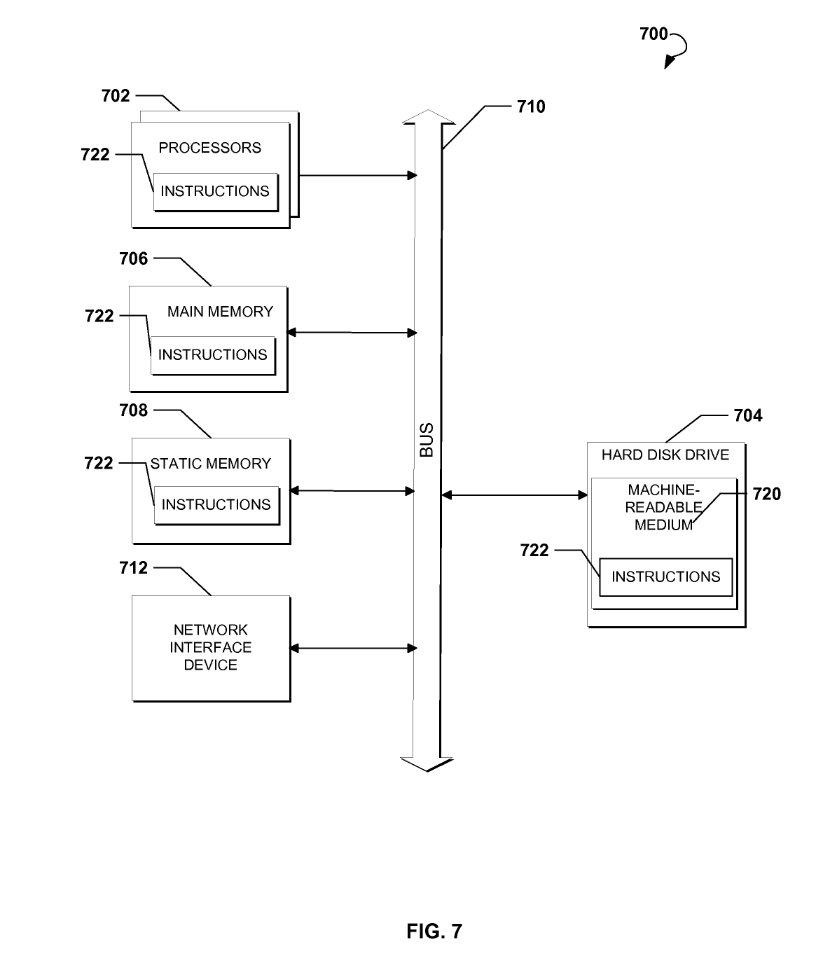

FIG. 7 shows a diagrammatic representation of a computing device for a machine in the exemplary electronic form of a computer system 700, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a server, a personal computer (PC), a tablet PC, a set-top box (STB), a PDA, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702, a hard disk drive 704, a main memory 706 and a static memory 708, which communicate with each other via a bus 710. The computer system 700 may also include a network interface device 712. The hard disk drive 704 may include a computer-readable medium 720, which stores one or more sets of instructions 722 embodying or utilized by any one or more of the methodologies or functions described herein. The instructions 722 can also reside, completely or at least partially, within the main memory 706 and/or within the processors 702 during execution thereof by the computer system 700. The main memory 706 and the processors 702 also constitute machine-readable media.

While the computer-readable medium 720 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, Python, Javascript, Go, or other compilers, assemblers, interpreters or other computer languages or platforms.

Thus, automatic ring discovery and configuration are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A method for auto-joining a data node to a data ring, the method comprising:
connecting a data node to a network;
periodically sending, by the data node, an advertisement to the network;
monitoring, by the data node, one or more further advertisements of one or more further data nodes associated with one or more data rings for a predetermined time period; and
based on the monitoring, selectively joining the data node to the data ring.

2. The method of claim 1, wherein the advertisement includes a notification of whether the data node is joined to the data ring.

3. The method of claim 1, wherein the one or more further advertisements of the one or more further data nodes associated with the one or more data rings include one or more of the following: a ring identifier, a data node identifier, a plurality of attributes, a software version, and an allowable number of nodes.

4. The method of claim 1, wherein the data node is operable to join the data ring if the one or more advertisements are received.

5. The method of claim 1, further comprising creating a new data ring if no advertisement is received within the predetermined time period.

6. The method of claim 5, wherein the one or more advertisements are updated in response to the creating of a new data ring.

7. The method of claim 1, further comprising selecting the data ring for the joining based on the one or more advertisements associated with the one or more data rings.

8. The method of claim 7, wherein the selecting is performed using predefined criteria, the predefined criteria including one or more of the following: a capacity of the one or more data rings, a number of nodes in the one or more data rings, an amount of free space in the one or more data rings, respective compatibility software versions of the data node and the one or more data rings.

9. The method of claim 7, wherein the selecting is performed randomly.

10. The method of claim 1, wherein the data node is operable to ignore the one or more data rings when an auto-join feature is disabled.

11. A system for auto-joining a data node to a data ring, the system comprising:
a processor configured to:
connect the data node to a network;
periodically send, by the data node, an advertisement to the network;
monitor, by the data node, one or more further advertisements of one or more further data nodes associated with one or more data rings for a predetermined time period; and
based on the monitoring, selectively join the data node to the data ring; and
a database communicatively coupled to the processor and configured to store data associated with the one or more data rings.

12. The system of claim 11, wherein a storage associated with the data node is available to the data ring after the joining.

13. The system of claim 11, wherein a configuration of the data ring is shared with the data node after the joining.

14. The system of claim 11, wherein a configuration of data nodes in the one or more data rings is ascertainable by a user.

15. The system of claim 11, wherein the processor is further configured to determine that the one or more advertisements associated with one or more data rings are received within the predetermined time period.

16. The system of claim 11, wherein the processor is further configured to determine an absence of the one or more advertisements associated with one or more data rings within the predetermined time period.

17. The system of claim 11, wherein the processor is further configured to create a new data ring, wherein the new data ring is created based on one or more of the following: an absence of the one or more advertisements, a compatibility of the one or more data rings and the data node, and an allowable number of members in the one or more data rings.

18. The system of claim 16, wherein the processor is further configured to:
in response to the creation, generate a ring identifier for the new data ring; and
update the one or more advertisements with the new data ring.

19. The system of claim 11, wherein the data node is operable to ignore the one or more data rings in response to disabling of an auto-join feature.

20. A non-transitory computer-readable medium comprising instructions, which when executed by one or more processors, perform the following operations:
connect the data node to a network;
periodically send, by the data node, an advertisement to the network;
monitor, by the data node, one or more further advertisements of one or more further data nodes associated with one or more data rings for a predetermined time period; and
based on the monitoring, selectively join the data node to the data ring.
